(19) United States
(12) Patent Application Publication
(10) Pub. No.: US 2026/0050833 A1
(43) Pub. Date: Feb. 19, 2026

(54) SUBGROUP DISCOVERY FOR SURVIVAL ANALYSIS

(71) Applicant: NEC Laboratories America, Inc., Princeton, NJ (US)

(72) Inventor: Zachary Izzo, Cranbury, NJ (US)

(21) Appl. No.: 19/285,420

(22) Filed: Jul. 30, 2025

Related U.S. Application Data
(60) Provisional application No. 63/682,468, filed on Aug. 13, 2024.

(51) Int. Cl. G06N 20/00

(52) U.S. Cl. CPC G06N 20/00

(57) ABSTRACT

Systems and methods for subgroup discovery for survival analysis. A survival analysis model can be fitted to neighborhoods of points from a dataset to obtain a fitted model. The neighborhoods of points can be filtered into a core group based on an expected prediction entropy metric. An undesirable event probability for the core group can be evaluated based on a conditional rank distribution of the core group to obtain rejected points. An axis-aligned hyperrectangle can be generated from an average of features in the core group to obtain a discovered subgroup, the axis-aligned hyperrectangle limited by the rejected points. An undesirable event for monitored entities predicted by a machine learning model that utilizes the discovered subgroup can be mitigated.

### RELATED APPLICATION INFORMATION

This application claims priority to U.S. Provisional App. No. 63/682,468, filed on Aug. 13, 2024, incorporated herein by reference in its entirety.

### BACKGROUND

### Technical Field

The present invention relates to data analysis to prevent undesirable events with artificial intelligence (AI), and more particularly to subgroup discovery for survival analysis.

### Description of the Related Art

Accuracy in predictions using artificial intelligence (AI) is proportional to the quality of data used for the prediction. A lower quality dataset would produce a lower accuracy in prediction. Thus, increasing the quality of a dataset would also increase the accuracy in prediction.

### SUMMARY

According to an aspect of the present invention, a method is provided including fitting a survival analysis model to neighborhoods of points from a dataset to obtain a fitted model, filtering the neighborhoods of points into a core group based on an expected prediction entropy metric, evaluating an undesirable event probability for the core group based on a conditional rank distribution of the core group to obtain rejected points, generating an axis-aligned hyperrectangle from an average of features in the core group to obtain a discovered subgroup, the axis-aligned hyperrectangle limited by the rejected points, and mitigating an undesirable event for monitored entities predicted by a machine learning model that utilizes the discovered subgroup.

According to another aspect of the present invention, a system is provided including a memory device, one or more processor devices operatively coupled with the memory device to perform operations, fitting a survival analysis model to neighborhoods of points from a dataset to obtain a fitted model, filtering the neighborhoods of points into a core group based on an expected prediction entropy metric, evaluating an undesirable event probability for the core group based on a conditional rank distribution of the core group to obtain rejected points, generating an axis-aligned hyperrectangle from an average of features in the core group to obtain a discovered subgroup, the axis-aligned hyperrectangle limited by the rejected points, and mitigating an undesirable event for monitored entities predicted by a machine learning model that utilizes the discovered subgroup.

According to yet another aspect of the present invention, a non-transitory computer program product including a computer-readable storage medium including a program code, wherein the program code when executed on a computer causes the computer to perform, fitting a survival analysis model to neighborhoods of points from a dataset to obtain a fitted model, filtering the neighborhoods of points into a core group based on an expected prediction entropy metric, evaluating an undesirable event probability for the core group based on a conditional rank distribution of the core group to obtain rejected points, generating an axis-aligned hyperrectangle from an average of features in the core group to obtain a discovered subgroup, the axis-aligned hyperrectangle limited by the rejected points, and mitigating an undesirable event for monitored entities predicted by a machine learning model that utilizes the discovered subgroup.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a system for subgroup discovery for survival analysis, in accordance with an embodiment of the present invention;

FIG. 2 is a block diagram of a computer system for subgroup discovery for survival analysis, in accordance with an embodiment of the present invention;

FIG. 3 is a block diagram showing hardware and software components of a computer system for subgroup discovery for survival analysis, in accordance with an embodiment of the present invention;

FIG. 4 is a block diagram showing a neural network for subgroup discovery for survival analysis, in accordance with an embodiment of the present invention; and

FIG. 5 is a flow diagram of a high-level overview of subgroup discovery for survival analysis, in accordance with an embodiment of the present invention.

### DETAILED DESCRIPTION OF PREFERRED EMBODIMENTS

In accordance with embodiments of the present invention, systems and methods are provided for subgroup discovery for survival analysis.

In an embodiment, a survival analysis model can be fitted to neighborhoods of points from a dataset to obtain a fitted model. The neighborhoods of points can be filtered into a core group based on an expected prediction entropy metric. An undesirable event probability for the core group can be evaluated based on a conditional rank distribution of the core group to obtain rejected points. An axis-aligned hyperrectangle can be generated from an average of features in the core group to obtain a discovered subgroup, the axis-aligned hyperrectangle limited by the rejected points. An undesirable event for monitored entities predicted by a machine learning model that utilizes the discovered subgroup can be mitigated.

Cox regression is a popular approach for survival analysis, where the goal is to model the distribution of the time until an event of interest conditional on relevant covariates. While the Cox regression model is appealing for its simplicity and ease of interpretability, it is known that in clinical settings, the data do not always satisfy the assumptions of the Cox regression model, leading to inaccurate predictions. Neural network-based methods for survival analysis have gained popularity in the machine learning community in recent years, and these methods are more flexible and capable of modeling more complex relationships in the data than the Cox regression model. However, due to their black-box, uninterpretable nature, these methods have not been widely employed in practice.

Previous works introduced a method for finding interpretable subgroups of the data on which an interpretable model is highly accurate. However, in these works, the base model is linear regression, which cannot handle censored data that is often encountered in survival analysis. This makes it less suitable for clinical settings of interest.

The present embodiments address the problem of using interpretable methods to accurately model survival data. Rather than trying to model the entire dataset simultaneously, the present embodiments instead find a subset of the data on which an interpretable survival analysis model, such as the cox regression model, is highly accurate. The subgroup itself is defined via easily interpretable criteria, namely, by thresholding the covariate values. Thus, in addition to improving the predictive accuracy of a predictive model, the discovered subgroups can also be used to define meaningful patient cohorts for future clinical study.

When model (e.g., Cox model) coefficients are used for drawing qualitative scientific inferences, rather than purely for prediction, the present embodiments can find subsets of the population with a qualitatively different relationship between a covariate and survival outcomes. For instance, in the general population, the relationship between the concentration of a novel drug and survival time is increased risk, meaning that the drug is not effective for most people. This would be represented by a positive coefficient on the drug concentration in the model trained on the entire dataset. However, for a small subgroup, the relationship may be reversed, meaning that an increased drug concentration reduces risk. This would be represented by a negative coefficient on the drug concentration, but only for that subgroup.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

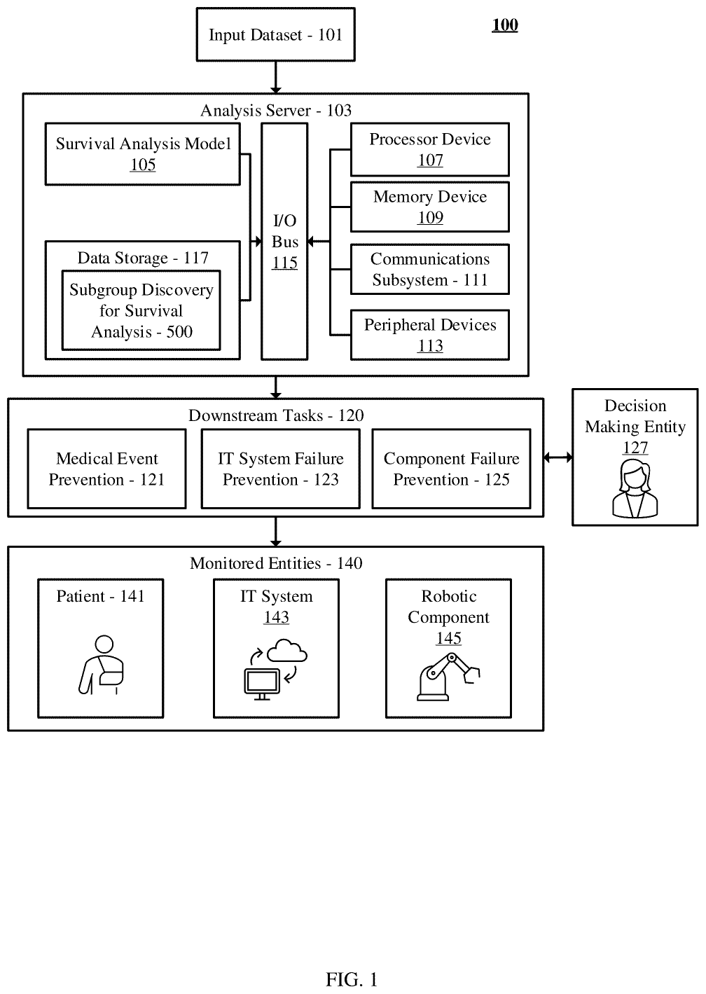

Referring now in detail to the figures in which like numerals represent the same or similar elements and initially to FIG. 1, a block diagram of a system for subgroup discovery for survival analysis, in accordance with an embodiment of the present invention.

In an embodiment, an input dataset 101 obtained from monitored entities 140 can be processed by an analysis server 103 to perform downstream tasks 120 and mitigate undesirable events predicted by the analysis server 103 based on the downstream tasks 120 for the monitored entities 140. The monitored entities 140 can include a patient 141, information technology (IT) system 143, and robotic component 145.

The downstream tasks 120 can include medical event prevention 121, IT system failure prevention 123, and component failure prevention 125. The system 100 can assist decision making entity 127 in its decision-making process for the downstream tasks.

In medical event prevention 121, the input dataset 101 can be obtained from a patient 141 for determining likelihood of success for a procedure (e.g., surgery, fertility preservation, artificial insemination, chemotherapy, drug efficiency, etc.). The system 100 can generate a corrective action to prevent and mitigate predicted undesirable medical events (e.g., organ failure, death, drug resistance, etc.) based on the discovered subgroup of the input dataset 101. The corrective action can include notifying the patient 141 (or decision-making entity 127 such as a healthcare professional) about the predicted undesirable medical events and generate recommendations (e.g., lifestyle changes, additional medical attention, calling an ambulance, injecting treatment, etc.) to mitigate and prevent the undesirable medical events.

In IT system failure prevention 123, the input dataset 101 can be obtained from an IT system 143 from logs, system data, etc. about the status of the IT system 143. The system 100 can generate a corrective action 130 to prevent predicted undesirable events (e.g., system outage, malicious attacks, etc.) based on the discovered subgroup of the input dataset 101. The corrective action can include blocking an internet protocol (IP) address of a predicted attacker, increasing bandwidth, increasing computational processing resources, etc. to prevent the undesirable events.

In component failure prevention 125, the input dataset 101 can be obtained from a robotic component 145 from logs, system data, etc. about the status of the robotic component 145 or with the system utilizing the robotic component 145 for downstream tasks such as manufacturing. The system 100 can generate a corrective action to prevent and mitigate predicted undesirable events (e.g., component failure, workflow failure, etc.) based on the discovered subgroup of the input dataset 101. The corrective action can include stopping the robotic component 145, cooling the robotic component 145, redirecting the workflow from the robotic component 145, etc., to prevent the undesirable events.

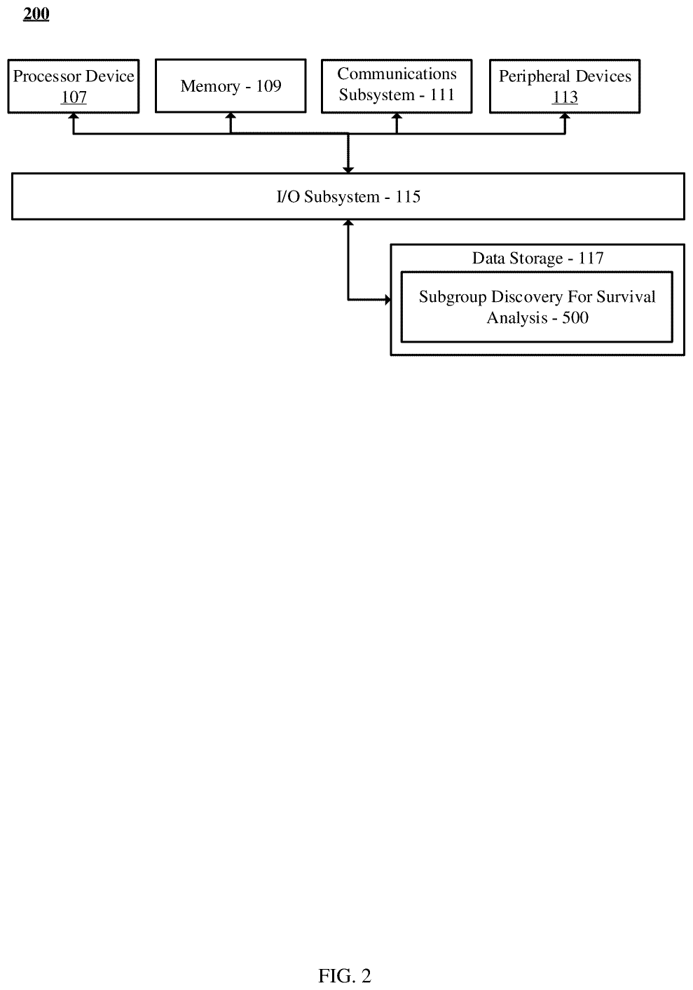

The analysis server 103 can include a survival analysis model 105, a data storage device 117, input/output (I/O) bus 115, a processor device 107, a memory 109, a communications subsystem 111, and peripheral devices 113. This is shown in more detail in FIG. 2.

Referring now to FIG. 2, a block diagram of a computer system for subgroup discovery for survival analysis, in accordance with an embodiment of the present invention.

In an embodiment, the computing device 200 can be implemented as the analysis server 103. The computing device 200 illustratively includes the processor device 107, the input/output (I/O) subsystem 115, the memory 109, the data storage device 117, and the communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 109, or portions thereof, may be incorporated in the processor device 107 in some embodiments.

The processor device 107 may be embodied as any type of processor capable of performing the functions described herein. The processor device 107 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 109 may be embodied as any type of volatile or non-volatile memory or data storage capable of performing the functions described herein. In operation, the memory 109 may store various data and software employed during operation of the computing device 200, such as operating systems, applications, programs, libraries, and drivers. The memory 109 is communicatively coupled to the processor device 107 via the I/O subsystem 115, which may be embodied as circuitry and/or components to facilitate input/output operations with the processor device 107, the memory 109, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 107, the memory 109, and other components of the computing device 200, on a single integrated circuit chip.

The data storage device 117 may be embodied as any type of device or devices configured for short-term or long-term storage of data such as, for example, memory devices and circuits, memory cards, hard disk drives, solid state drives, or other data storage devices. The data storage device 117 can store program code for subgroup discovery for survival analysis 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 113. The peripheral devices 113 may include any number of additional input/output devices, interface devices, and/or other peripheral devices. For example, in some embodiments, the peripheral devices 113 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

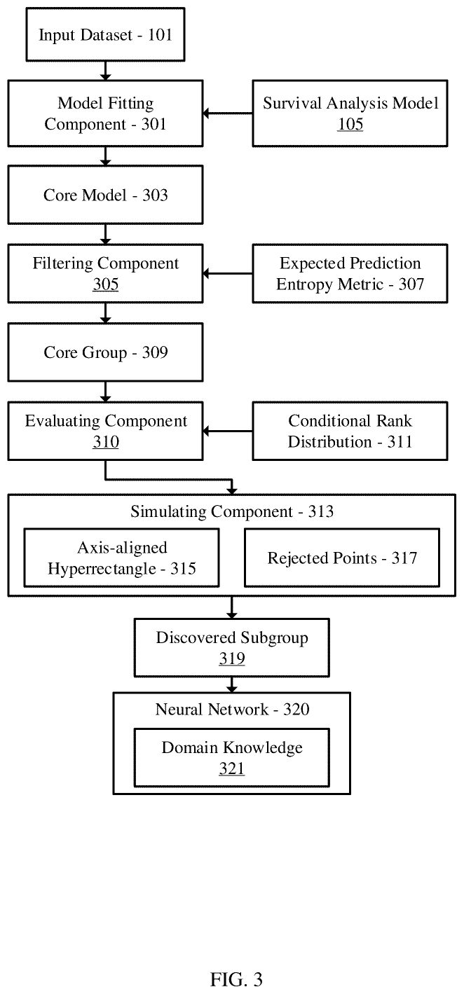

Referring now to FIG. 3, a block diagram showing hardware and software components of a computer system for subgroup discovery for survival analysis, in accordance with an embodiment of the present invention.

In system 200, an input dataset 101 can be processed by a model fitting component 301 to fit the input dataset 101 into the survival analysis model 105 as a core model 303.

The survival analysis model 105 can include a cox regression model, log-rank model, Kaplan-Meier model, etc. The input dataset 101 with the core model 303 can be processed by a filtering component 305 which can filter a core group 309 from the input dataset 101 based on the core model 303.

The core group 309 and core model 303 can be processed by an evaluating component 310 that can compute the conditional rank distribution 311 of the core group 309 and the core model 303.

A simulating component 313 can process the core group 309 and core model 303 to obtain rejected points 317 and an axis-aligned hyperrectangle 315. The rejected points 317 can include datapoints that cannot feasibly belong to the same subgroup as the points in the core group 309. The rejected points 317 limits the axis-aligned hyperrectangle 315 and is filtered from the discovered subgroup 319. The points within the axis-aligned hyperrectangle 315 can be included in the discovered subgroup 319.

The input data 101 that corresponds to the discovered subgroup 319 can be processed by a neural network 320 to learn a domain knowledge 321 to perform downstream tasks 120. The neural network 320 can then generate the corrective action 130.

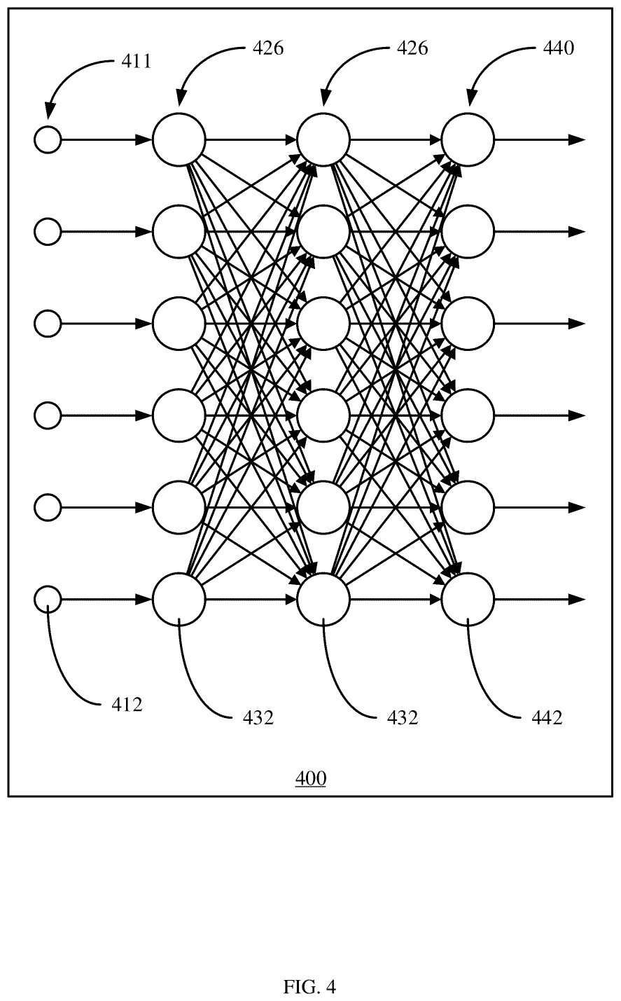

Referring now to FIG. 4, a block diagram showing a neural network for subgroup discovery for survival analysis, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 400, such as a multilayer perceptron, can have an input layer 411 of source neurons 412, one or more computation layer(s) 426 having one or more computation neurons 432, and an output layer 440, where there is a single output neuron 442 for each possible category into which the input example could be classified. An input layer 411 can have a number of source neurons 412 equal to the number of data values 412 in the input data 411. The computation neurons 432 in the computation layer(s) 426 can also be referred to as hidden layers, because they are between the source neurons 412 and output neuron(s) 442 and are not directly observed. Each neuron 432, 442 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 432 in the one or more computation (hidden) layer(s) 426 perform a nonlinear transformation on the input data 412 that generates a feature space. The classes or categories may be more easily separated in the feature space than in the original data space.

In an embodiment, the computation layers 426 of the neural network 320 can learn the relationships between the input data 101 that corresponds with the discovered subgroup 319 and learned domain knowledge 321 of the neural network for downstream tasks 120. The output layer 440 can then output a likelihood of an undesirable event based input data 101 that corresponds with the discovered subgroup 319. In another embodiment, the output layer 440 can generate a corrective action 130 based on the input data 101 that corresponds with the discovered subgroup 319 and the learned domain knowledge 321.

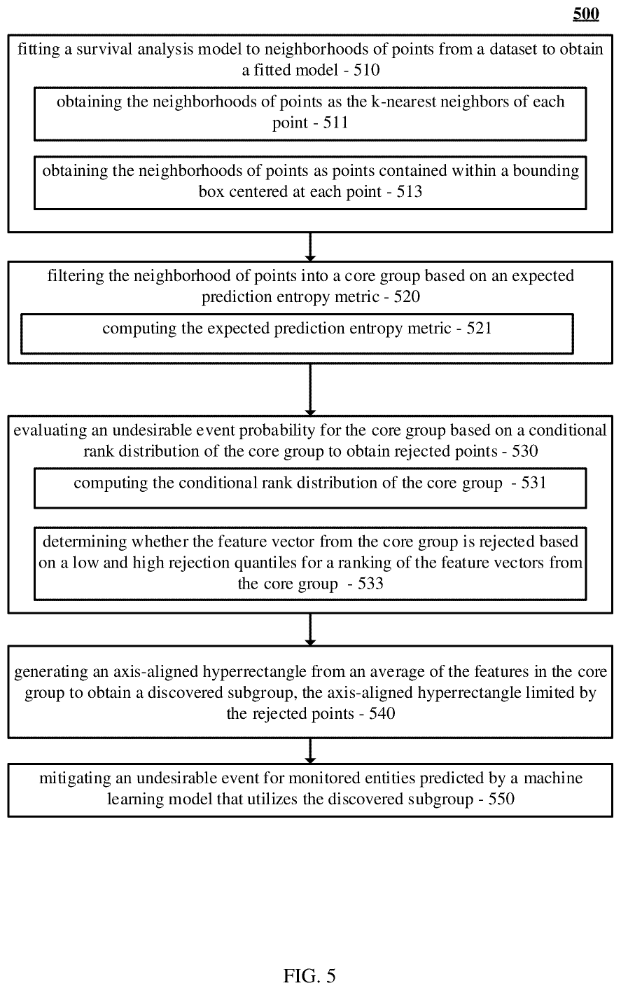

Referring now to FIG. 5, a flow diagram of a high-level overview of subgroup discovery for survival analysis, in accordance with an embodiment of the present invention.

In an embodiment, a survival analysis model can be fitted to neighborhoods of points from a dataset to obtain a fitted model. The neighborhoods of points can be filtered into a core group based on an expected prediction entropy metric. An undesirable event probability for the core group can be evaluated based on a conditional rank distribution of the core group to obtain rejected points. An axis-aligned hyperrectangle can be generated from an average of features in the core group to obtain a discovered subgroup, the axis-aligned hyperrectangle limited by the rejected points. An undesirable event for monitored entities predicted by a machine learning model that utilizes the discovered subgroup can be mitigated.

Input dataset 101 can be denoted in the form

$$D = {\{ ( {x}_{i} , {t}_{i} , {δ}_{i} ) \}}_{i = 1}^{n} , where {x}_{i} ∈ {ℝ}^{d}$$

are feature vectors, tᵢ∈ [symbol] ≥0 is the time to some event (failure or censoring), and δᵢ∈{0, 1} is a censoring variable where δᵢ=1 indicates that the i-th datapoint experienced failure (e.g., tᵢ is the actual failure time) and δᵢ=0 indicates that it was censored (where tᵢ is the censoring time and that the true failure time is at least tᵢ). The risk set Rᵢ can be defined as the i-th point to be the set of points which have not failed or been censored just before time tᵢ. That is, assuming tied censoring or failure times occur with probability 0, Rᵢ contains the i-th datapoint and all other datapoints j with tⱼ≥tᵢ.

In block 510, a survival analysis model can be fitted to neighborhoods of points from a dataset to obtain a fitted model.

A survival analysis model 105 can be fitted by the model fitting component 301 to the input dataset 101 through to the neighborhood of each point in the input dataset 101.

In block 511, the neighborhoods can be defined as the k nearest neighbors of each point. In block 513, the neighborhoods can be defined as points contained within a certain bounding box centered at each point. The core model 303 is the resulting survival analysis model 105 fitted into the input dataset 101.

In block 520, the neighborhoods of points can be filtered into a core group based on an expected prediction entropy metric.

The expected prediction entropy (EPE) metric 307 can be computed for each neighborhood and resulting core model 303 by the filtering component 305. The group of points with the lowest EPE is selected as the core group 309.

Given an input dataset

$$101 D = {\{ ( {x}_{i} , {t}_{i} , {δ}_{i} ) \}}_{i = 1}^{n} ,$$

the expected prediction entropy (EPE) metric 307 of a hazard model (e.g., survival analysis model 105) λ(t; x) on D is defined as:

$$EPE ( λ , D ) = - \frac{1}{N} {\sum }_{i : {δ}_{i} = 1} {\sum }_{j ∈ {R}_{i}} log ( \frac{λ ( {t}_{i} ; {x}_{i} )}{λ ( {t}_{i} ; {x}_{i} ) + λ ( {t}_{i} ; {x}_{j} )} ) , \qquad ( 1 )$$

where N=Σ_{i: δ}_{ᵢ}₌₁|Rᵢ| is the total number of comparable events. For example, with the standard survival analysis model 105, such as the Cox model, as λ(t; x)=λ₀(t)e^{β}^{^{τ}}^{x} for some unknown baseline hazard function λ₀(t), so the summand in (1) is 1/(e^{β}^{^{τ}}^{(x}^{ᵢ}^{-x}^{ⱼ}⁾). A low prediction entropy (PE) means that the model confidently and accurately predicts the relative failure times of the patients. Finding a group with low PE means that a collection of patients for whom a predictive model is very accurate have been identified. This can lead to a more effective personalized treatment. The present embodiments can apply to any survival analysis model 105 which predicts a hazard rate model. Since the PE for the survival analysis model 105 depends only on the relative hazard coefficient β and not the full hazard function λ, the EPE(β, D) can refer to the EPE for the hazard function λ(t; x)=λ₀(t)e^{β}^{^{τ}}^{x} for some fixed but arbitrary λ₀. A core group 309 which minimizes the prediction entropy can be selected, where β is fit to the points in the core group 309.

In block 530, an undesirable event probability for the core group can be evaluated based on a conditional rank distribution of the core group to obtain rejected points.

For each point in the dataset, its conditional rank distribution (CRD) 311 can be computed according to the core group 309 and core model 303. The CRD 311 can be utilized to determine the feasibility of datapoints to be included in the core group. If it is not feasible for a datapoint to be included in the core group, that datapoint is rejected and can be included in the rejected points 317

Specifically, let β be the fitted model coefficients and x₁, . . . , xₙ be the feature vectors in the core group 309, labeled such that t₁<t₂< . . . <tₙ. The core group 309 features can be collected into the n×d data matrix X and the failure times into the n vector T. For a “test” point with features x* and failure time t*, the probability that the rank of x* is at least as extreme (high or low) as its observed value can be computed conditional on the other observed failure times and assuming that x* follows the same survival analysis model 105 as the core group 309.

In block 531, the conditional rank distribution of x* can be computed, defined as:

$${r}_{k}^{c} ( {x}^{*} ; X , β ) = ℙ ( {t}_{k - 1} < {t}^{*} < {t}_{k} \vert {x}^{*} ; X ; {t}_{1} < ⋯ < {t}_{n} ) , \qquad ( 2 )$$

where the probability is computed assuming each pair (x, t) follows the same survival analysis model 105 with fixed (unknown) baseline hazard function λ₀(t) and hazard coefficient β.

It will also be convenient to define the unconditional rank probabilities of x* as

$${r}_{k} ( {x}^{*} ; X , β ) = ℙ ( {t}_{1} < ⋯ < {t}_{k - 1} < {t}^{*} < {t}_{k} < ⋯ < {t}_{n} \vert {x}^{*} , X ) , \qquad ( 3 )$$

This is the same as the conditional rank distribution, but have not conditioned on the ranks of the failure times of the units in the core group 309. By Bayes' rule, the unconditional rank probabilities of x* is:

$${r}_{k} ( {x}^{*} ; X , β ) = \frac{ℙ ( {t}_{1} < ⋯ < {t}_{k - 1} < {t}^{*} < {t}_{k} < ⋯ < {t}_{n} \vert {x}^{*} , X )}{ℙ ( {t}_{1} < ⋯ < {t}_{n} \vert {x}^{*} , X )}$$

$$\begin{matrix}= \frac{ℙ ( {t}_{1} < ⋯ < {t}_{k - 1} < {t}^{*} < {t}_{k} < ⋯ < {t}_{n} \vert {x}^{*} , X )}{{\sum }_{j = 1}^{n} ℙ ( {t}_{1} < ⋯ < {t}_{j - 1} < {t}^{*} < {t}_{j} < ⋯ < {t}_{n} \vert {x}^{*} , X )} \\ = \frac{{r}_{k} ( {x}^{*} ; X , β )}{{\sum }_{j = 1}^{n} {r}_{j} ( {x}^{*} ; X , β )} ,\end{matrix} \qquad ( 4 )$$

It thus suffices to compute the unconditional rank probabilities of x*.

Conditional on the Cox coefficients β, explicit formulas for the unconditional rank probabilities of x* can be derived. In particular, by writing the probability that t₁< . . . <tₖ₋₁<t*<tₖ< . . . <tₙ as the probability of the next failure being the “correct” one given that the failures have occurred in the specified order so far, the explicit formula is:

$${r}_{k} ( {x}^{*} ; X , β ) = {\prod }_{i = 1}^{n + 1} \frac{exp ( {β}^{T} {x}_{i}^{( k )} )}{{\sum }_{j = 1}^{n + 1} exp ( {β}^{T} {x}_{i}^{( k )} )} , \qquad ( 5 )$$

$$where {x}_{i}^{( k )} = \{ \begin{matrix}{x}_{i} , i < k \\ {x}^{*} , i = k , \\ {x}_{i - 1} , i > k\end{matrix} i . e . , \qquad ( 6 )$$

the i-th feature vector when x* has been “inserted” in the k-th position. By plugging equation (5) into (4), the conditional rank distribution of x* can be computed. Finally, let rank(x*) denote the random variable whose value is the rank of the “test” unit with features x*, and let k* be its observed value (i.e., the rank of t* among t₁, . . . , tₙ).

In block 533, whether or not to reject x* by comparing k* with qₗₒ and qₕᵢ, which denote the low and high rejection quantiles for the rank can be determined with:

$${q}_{lo} = max \{ k : {\sum }_{i < k} {r}_{i}^{c} ( {x}^{*} ; X , β ) < \frac{α}{2} \} ,$$

$${q}_{hi} = min \{ k : {\sum }_{i > k} {r}_{i}^{c} ( {x}^{*} ; X , β ) < \frac{α}{2} \} .$$

Equivalently, the rank tail statistic can be defined as τ*=min{ [symbol] (rank(x*)≤k*), [symbol] (rank(x*)≥k*)} and check whether τ*<α/2. In particular, the rejection label [symbol] * for each datapoint can be set to [symbol] *= [symbol] {τ*<α/2}.

The conditional rank distribution 311 has a straightforward generalization to the partial likelihood and censored data. The distribution of possible failure times can be considered for x* among all of the events (failure or censoring) experienced by the other points. Based on the actual rank of x* (i.e., if it failed), a two-tailed test can be conducted after computing the distribution. If x* was censored, then only a test based on its right tail can be formed. Let t₁, < . . . <tₙ be the event times for the points with features x₁, . . . , xₙ in the core group, and let δᵢ be the corresponding failure indicators (δᵢ= [symbol] {xᵢ failed (was not censored) at time tᵢ}). The partial likelihood that x* fails with event rank k is

$${r}_{k} ( {x}^{*} ; X , δ , β ) = {\prod }_{i = 1}^{n + 1} {( \frac{exp ( {β}^{T} {x}_{i}^{( k )} )}{{\sum }_{j = 1}^{n + 1} exp ( {β}^{T} {x}_{j}^{( k )} )} )}^{{δ}_{i}} = {\prod }_{i : {δ}_{i} = 1} \frac{exp ( {β}^{T} {x}_{i}^{( k )} )}{{\sum }_{j = 1}^{n + 1} exp ( {β}^{T} {x}_{j}^{( k )} )} , \qquad ( 7 )$$

$$where {x}_{i}^{( k )}$$

is the i-th feature vector when x* has been “inserted” in the k-th position. Note that this is simply the standard Cox partial likelihood if x* fails as the k-th event. The conditional failure “probabilities”

$${r}_{k}^{c} ( {x}^{*} ; X , δ , β )$$

are then defined analogously to equation (2). The rank tail statistic and associated rejection labels can be computed exactly as in the uncensored case.

A naive implementation of the conditional rank tail probability took over 20 seconds to evaluate on a single point in some early experiments. Thus, a faster implementation is necessary. To avoid cumbersome notation, the abbreviation rₖ=rₖ(x*; X, δ, β) can be used. The naive computation of a single rₖ from equation (5) will require Ω(n²) time. This can easily be reduced to O(n) by updating the partial sum contained in the denominator as each term in the product is computed, rather than recomputing it from scratch each time. With this modification, r₁ can be computed in O(n) time. Another speedup can be obtained by computing the remaining rₖ recursively, rather than repeatedly using the procedure above from scratch for each rₖ. A direct calculation using the formula (7) shows that:

$${r}_{k + 1} = \frac{( 1 - {δ}_{k} ) {e}^{{β}^{T} {x}^{*}} + {S}_{k}}{{e}^{{β}^{T} {x}^{*}} - {e}^{{β}^{T} x} k + {S}_{k}} \cdot {r}_{k} , \qquad ( 8 )$$

$$where {S}_{k} = {\sum }_{i = k}^{n} {e}^{{β}^{T} {x}_{i}} .$$

Using the running partial sum trick to quickly compute Sₖ (rather than computing from scratch each time), the next rₖ₊₁ can be computed in constant time using the previous one. This means that r₁, . . . , rₙ₊₁ can all be computed using only O(n) time total.

The rank probabilities rₖ can be replaced with the logarithms since when working with large datasets, working directly with the product of many probabilities (even when each is individually of “reasonable” size) can lead to numerical issues. Given the set of log rₖ, the conditional probability distribution

$$311 {r}_{k}^{c}$$

can then be computed by taking a softmax.

In block 340, an axis-aligned hyperrectangle can be generated from an average of features in the core group to obtain a discovered subgroup, the axis-aligned hyperrectangle limited by the rejected points.

Once a core group 309 have been determined and rejected points 317, which cannot feasibly follow the same model as the core group 309, the discovered subgroup 319 can be obtained using the rejection labels. Specifically, starting from the mean of the features in the core group 309, the sides of the axis-aligned hyperrectangle 315 can be expanded. The axis-aligned hyperrectangle 315 can be initiated with values that coincide with an infinity norm on [symbol] ^{d}. Each side continues expanding until it collides with a rejected point, at which time this side stops moving outward. This continues until all of the sides have collided with a rejected point 317, or until they reach some maximum allowed value. The discovered subgroup 319 includes of all points lying in the axis-aligned hyperrectangle 315.

In block 350, an undesirable event for monitored entities predicted by a machine learning model that utilizes the discovered subgroup can be mitigated.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
fitting a survival analysis model to neighborhoods of points from a dataset to obtain a fitted model;
filtering the neighborhoods of points into a core group based on an expected prediction entropy metric;
evaluating an undesirable event probability for the core group based on a conditional rank distribution of the core group to obtain rejected points;
generating an axis-aligned hyperrectangle from an average of features in the core group to obtain a discovered subgroup, the axis-aligned hyperrectangle limited by the rejected points; and
mitigating an undesirable event for monitored entities predicted by a machine learning model that utilizes the discovered subgroup.

2. The method of claim 1, wherein mitigating the undesirable event further comprises notifying patients within the discovered subgroup about the undesirable event and recommendations to mitigate the undesirable event through automated decision making.

3. The method of claim 1, wherein fitting the survival analysis model further comprises obtaining the neighborhoods of points as k-nearest neighbors of each point.

4. The method of claim 1, wherein fitting the survival analysis model further comprises obtaining the neighborhoods of points as points contained within a bounding box centered at each point.

5. The method of claim 1, wherein filtering the neighborhoods of points further comprises computing the expected prediction entropy metric as:
$$EPE ( λ , D ) = - \frac{1}{N} {\sum }_{i : {δ}_{i} = 1} {\sum }_{j ∈ {R}_{i}} log ( \frac{λ ( {t}_{i} ; {x}_{i} )}{λ ( {t}_{i} ; {x}_{i} ) + λ ( {t}_{i} ; {x}_{j} )} )$$
where D is an input dataset
$$D = {\{ ( {x}_{i} , {t}_{i} , {δ}_{i} ) \}}_{i = 1}^{n} , {δ}_{i} ∈ \{ 0 , 1 \}$$
is a censoring variable, λ(t; x) is a hazard model of feature vector x for time t, n is a total number of data in the input dataset.

6. The method of claim 1, wherein evaluating the undesirable event probability further comprises computing the conditional rank distribution of the core group as:
$${r}_{k}^{c} ( {x}^{*} ; X , β ) = ℙ ( {t}_{k - 1} < {t}^{*} < {t}_{k} \vert {x}^{*} ; X ; {t}_{1} < ⋯ < {t}_{n} ) ,$$
where x* is a desired feature vector, at failure time t*, β is a core model coefficient, t is a time value.

7. The method of claim 1, evaluating the undesirable event probability further comprises determining whether a feature vector from the core group is rejected based on a low and high rejection quantiles for a ranking of the feature vectors from the core group.

8. A system, comprising:
a memory device;
one or more processor devices operatively coupled with the memory device to perform operations, the operations including:
fitting a survival analysis model to neighborhoods of points from a dataset to obtain a fitted model;
filtering the neighborhoods of points into a core group based on an expected prediction entropy metric;
evaluating an undesirable event probability for the core group based on a conditional rank distribution of the core group to obtain rejected points;
generating an axis-aligned hyperrectangle from an average of features in the core group to obtain a discovered subgroup, the axis-aligned hyperrectangle limited by the rejected points; and
mitigating an undesirable event for monitored entities predicted by a machine learning model that utilizes the discovered subgroup.

9. The system of claim 8, wherein mitigating the undesirable event further comprises notifying patients within the discovered subgroup about the undesirable event and recommendations to mitigate the undesirable event through automated decision making.

10. The system of claim 8, wherein fitting the survival analysis model further comprises obtaining the neighborhoods of points as k-nearest neighbors of each point.

11. The system of claim 8, wherein fitting the survival analysis model further comprises obtaining the neighborhoods of points as points contained within a bounding box centered at each point.

12. The system of claim 8, wherein filtering the neighborhoods of points further comprises computing the expected prediction entropy metric as:
$$EPE ( λ , D ) = - \frac{1}{N} {\sum }_{i : {δ}_{i} = 1} {\sum }_{j ∈ {R}_{i}} log ( \frac{λ ( {t}_{i} ; {x}_{i} )}{λ ( {t}_{i} ; {x}_{i} ) + λ ( {t}_{i} ; {x}_{j} )} )$$
where D is an input dataset
$$D = {\{ ( {x}_{i} , {t}_{i} , {δ}_{i} ) \}}_{i = 1}^{n} , {δ}_{i} ∈ \{ 0 , 1 \}$$
is a censoring variable, λ(t; x) is a hazard model of feature vector x for time t, n is a total number of data in the input dataset.

13. The system of claim 8, wherein evaluating the undesirable event probability further comprises computing the conditional rank distribution of the core group as:
$${r}_{k}^{c} ( {x}^{*} ; X , β ) = ℙ ( {t}_{k - 1} < {t}^{*} < {t}_{k} \vert {x}^{*} ; X ; {t}_{1} < ⋯ < {t}_{n} ) ,$$
where x* is a desired feature vector, at failure time t*, β is a core model coefficient, t is a time value.

14. The system of claim 8, evaluating the undesirable event probability further comprises determining whether a feature vector from the core group is rejected based on a low and high rejection quantiles for a ranking of the feature vectors from the core group.

15. A non-transitory computer program product comprising a computer-readable storage medium including a program code, wherein the program code when executed on a computer causes the computer to perform:
fitting a survival analysis model to neighborhoods of points from a dataset to obtain a fitted model;
filtering the neighborhoods of points into a core group based on an expected prediction entropy metric;
evaluating an undesirable event probability for the core group based on a conditional rank distribution of the core group to obtain rejected points;
generating an axis-aligned hyperrectangle from an average of features in the core group to obtain a discovered subgroup, the axis-aligned hyperrectangle limited by the rejected points; and
mitigating an undesirable event for monitored entities predicted by a machine learning model that utilizes the discovered subgroup.

16. The non-transitory computer program product of claim 15, mitigating the undesirable event further comprises notifying patients within the discovered subgroup about the undesirable event and recommendations to mitigate the undesirable event through automated decision making.

17. The non-transitory computer program product of claim 15, wherein fitting the survival analysis model further comprises obtaining the neighborhoods of points as k-nearest neighbors of each point.

18. The non-transitory computer program product of claim 15, wherein fitting the survival analysis model further comprises obtaining the neighborhoods of points as points contained within a bounding box centered at each point.

19. The non-transitory computer program product of claim 15, wherein filtering the neighborhoods of points further comprises computing the expected prediction entropy metric as:
$$EPE ( λ , D ) = - \frac{1}{N} {\sum }_{i : {δ}_{i} = 1} {\sum }_{j ∈ {R}_{i}} log ( \frac{λ ( {t}_{i} ; {x}_{i} )}{λ ( {t}_{i} ; {x}_{i} ) + λ ( {t}_{i} ; {x}_{j} )} )$$
where D is an input dataset
$$D = {\{ ( {x}_{i} , {t}_{i} , {δ}_{i} ) \}}_{i = 1}^{n} , {δ}_{i} ∈ \{ 0 , 1 \}$$
is a censoring variable, λ(t; x) is a hazard model of feature vector x for time t, n is a total number of data in the input dataset.

20. The non-transitory computer program product of claim 15, wherein evaluating the undesirable event probability further comprises computing the conditional rank distribution of the core group as:
$${r}_{k}^{c} ( {x}^{*} ; X , β ) = ℙ ( {t}_{k - 1} < {t}^{*} < {t}_{k} \vert {x}^{*} ; X ; {t}_{1} < \cdot \cdot$$
where x* is a desired feature vector, at failure time t*, β is a core model coefficient, t is a time value.
